(19) United States
(12) Patent Application Publication
(10) Pub. No.: US 2004/0246510 A1
(43) Pub. Date: Dec. 9, 2004

(54) Methods and systems for use of a gradient operator

(76) Inventors: Dana A. Jacobsen, Boise, ID (US); Terry-Lee M. Fritz, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/456,707

(22) Filed: Jun. 6, 2003

(51) Int. Cl. G06T 11/00; G06F 3/12; G06F 17/00

(52) U.S. Cl. 358/1.9; 715/911; 358/1.16

(57) ABSTRACT

In one embodiment, a method evaluates data associated with a print job to ascertain whether the data is associated with a gradient. At least a portion of the data is replaced with a gradient operator if the portion is determined to be associated with the gradient.

### BACKGROUND

One feature that is being used more commonly today in the context of color printers is color gradients. A color gradient can be employed in the context of an object that has a color transition within it. For example, consider the case of a PowerPoint presentation that utilizes a background color that might start at the upper left portion of a page as light blue color, and then transition diagonally downward and to the right of the page to progressively darker colors of blue. There can be different kinds of gradients such as vertical gradients (which transition in color vertically on the page), horizontal gradients (which transition in color horizontally on the page) and various types of complex gradients such as radial gradients (which transition in a radial direction on the page).

Representing these gradients for purposes of printing them on a printer, such as a color printer, can take a large amount of memory. Using gradient operators, gradients can be represented in a way that uses less memory. However, there can arise instances in which the gradient operators are not used. When this occurs, large amounts of valuable and limited printer memory may be consumed to represent the gradient.

### SUMMARY

In one embodiment, a method evaluates data associated with a print job to ascertain whether the data is associated with a gradient. At least a portion of the data is replaced with a gradient operator if the portion is determined to be associated with the gradient.

### BRIEF DESCRIPTION OF THE DRAWINGS

FIG. 1 is a block diagram of an exemplary printing system in connection with which one or more embodiments can be implemented.

FIG. 2 is a flow diagram that describes steps in a method in accordance with one embodiment.

FIG. 3 is a block diagram of an exemplary optimizer in accordance with one embodiment.

FIG. 4 is a diagrammatic representation of an exemplary optimizer and illustrates exemplary locations where the optimizer can be located.

### DETAILED DESCRIPTION

Overview

Most color laser printers receive an image of a page to be printed in the form of a page description language (PDL) such as PCL or PostScript. The PDL is used to construct a raster image which is then fed to a print engine for imaging onto a media sheet. More precisely, a page description is typically built in two steps. During formatting, the page description language is converted into a series of commands, called display commands which describe what is to be rasterized. The display commands for a color printer typically include but are not limited to color commands that describe a particular color that is to be printed, and vectors that positionally indicate where on the media sheet the color is to be rendered. Further, the display commands are sorted according to their vertical position on the page and are placed into “strips”. Each strip is then listed on a “display list” which holds all display commands for the strip. Thereafter, each display list is processed to extract the display commands which are converted into a rasterized pixel image at a fast enough pace to maintain a constant flow of rasterized data to the print engine. For additional information on display lists and how they are created and processed, the reader is referred to the following U.S. patents, assigned to the assignee of this document: U.S. Pat. Nos. 6,097,496; and 5,805,174.

To conserve memory, the laser printer is provided with a plurality of raster buffers, with each buffer having sufficient capacity to handle the rasterized form of a strip. Each buffer is reused as its rasterized data is fed to the print engine and is rendered onto the media sheet.

When gradients are represented as individual display commands, a huge amount of memory can be required. This is because of the large number of color commands and vectors that are required to describe the gradient.

Some components in the printing process may, however, support what is known as a gradient operator. A gradient operator is a function that provides an efficient way to represent a gradient. A gradient operator can comprise a command that essentially indicates the type of gradient to draw. Thus, rather than representing the gradient as a series of color commands and vectors, the gradient operator can be used to represent the gradient.

Even in view of the convenience that gradient operators can provide, problems can still arise that necessarily adversely impact the performance of the printer. For example, suppose that the particular PDL has a gradient operator that describes the particular gradient that is to be printed. If the particular components in the chain of components that process image data (such as the application or driver) do not support such a gradient operator, the gradient will come down to the display list as a series of color commands and vectors. Thus, there are no economies to be gained here. Alternately, suppose that the particular PDL does not support a gradient operator but that the printer's processing chain components do support gradient operators. In this case, the gradient operator would not be used by the system and hence the economies that are gained from using a gradient operator are lost.

Methods and systems are described that are directed to improving the efficiencies that can be gained through the use of gradient operators. The described methods and systems evaluate data that is associated with a print job and look for characteristics that are associated with a gradient. If gradient characteristics are found, then the corresponding data is replaced with a more efficient representation of the gradient in the form of a gradient operator. Gradient operators can consume less memory space in the printer and can be more effectively and efficiently processed by the printing system for printing the gradient.

Exemplary Printer System

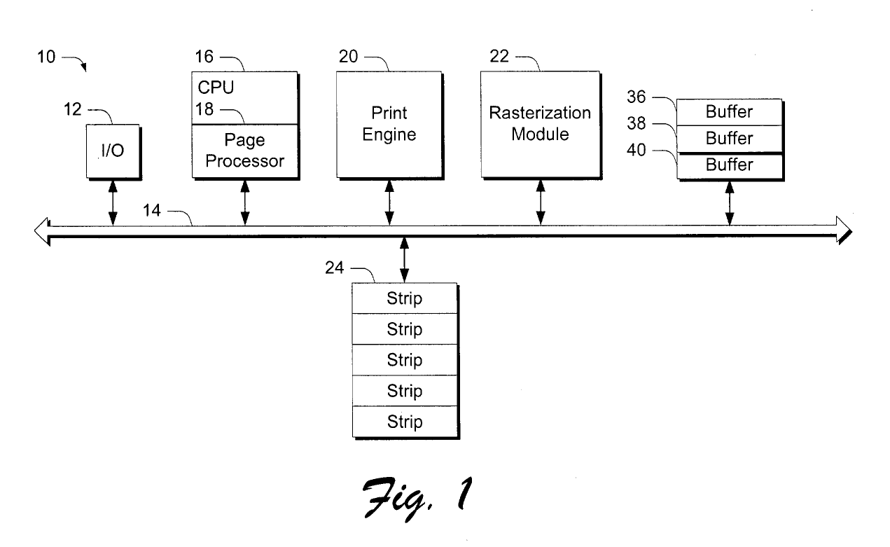

FIG. 1 shows an exemplary printing system, generally at 10, in which the inventive embodiments can be employed. It is to be appreciated that the illustrated system constitutes but one system in connection with which the inventive embodiments can be employed. Accordingly, other printing systems can be utilized without departing from the spirit and scope of the claimed subject matter.

Printing system 10 comprises an I/O module 12 via which it receives input page description information from a host processor. The information is fed, via a bus system 14 and is stored in memory. A central processing unit (CPU) 16 controls the overall operation of printing system 10, and includes a page processor procedure 18 which, in conjunction with the remaining elements of printing system 10, controls conversion of the page description language to rasterized data that is suitable for transfer to a print engine 20. Printing system 10 further includes a rasterization module 22 which converts an intermediate form of page image data to rasterized image data that is suitable for rendering by print engine 20.

Under control of page processor 18, the page description language from the printer's memory is converted to a plurality of strips 24, each of which comprises an associated display list. Collectively, strips 24 comprise page intermediate data which defines the images to be placed on the media sheet being processed by print engine 20.

Each strip can include, among other items, color commands that define a color that is to be rendered and vectors that define where the colors are to be rendered.

After display lists have been created for every strip of a page, the strips are ready to be rasterized and passed to print engine 20. At such time, the strips are processed, typically but not limited to, in the order in which they will be sent to the print engine. For each strip, the commands on the display list are parsed and sent to the rasterization module 22. Once a strip has been rasterized it is sent to the print engine 20. Print engine 20 may compress these strips and store them for later printing, or may print them immediately. This is one description only and it is not meant to limit application of the claimed subject matter to only systems that behave as described above. Rather, the claimed subject matter can be utilized in connection with systems that behave differently than the system described immediately above.

In the process of rasterizing a strip, rasterization module 22 can utilize one of a plurality of video buffers 36, 38, and 40. It is to be understood that three video buffers are shown for exemplary purposes only and that any number of video buffers may be utilized, if sufficient memory is available.

In essence, once a strip has been rasterized, the rasterized data is stored in a respective video buffer, and control of the video buffer is then transferred to print engine 20 so that its data may be printed. Once the data has been printed from the respective video buffer, the video buffer is assigned for use with a next strip for rasterization. This action typically occurs in a round-robin manner.

Exemplary Embodiment

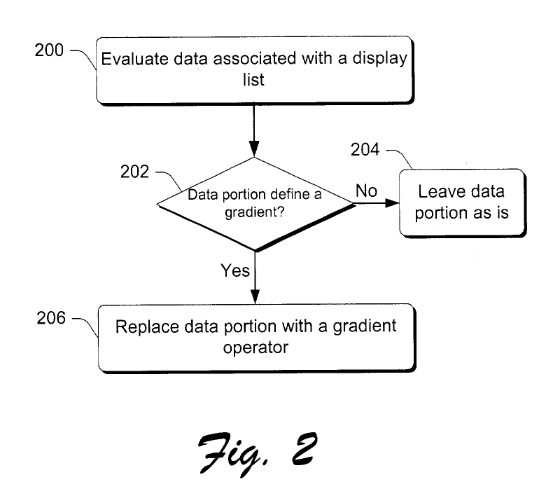

FIG. 2 is a flow diagram that describes steps in a method in accordance with one embodiment. The method can be implemented in any suitable hardware, software, firmware or combination thereof. In one embodiment, the method can be implemented in connection with a system, such as the system shown and described above.

Step 200 evaluates data associated with a display list. The step can be accomplished in any suitable way, examples of which are provided below. The data that is evaluated can comprise the data of the display list itself. Alternately or additionally, the data that is evaluated can comprise the data of the PDL that is processed to provide the display list data.

Step 202 determines whether a data portion of the display list data defines a gradient. This step can be implemented in any suitable way, examples of which are provided below. If step 202 determines that the data portion does not define a gradient, then step 204 leaves the data portion as it is. If, on the other hand, step 202 determines that the data portion defines a gradient, step 206 replaces the data portion with a gradient operator. The gradient operator that replaces the data portion is selected such that it effectively produces, when processed by the printer's image processor and print engine, a printed gradient that is the same as or suitably close to that which would have been printed had the display list's data portion not been replaced.

A principle which various embodiments may use is that data that defines gradients (whether that data is display list data or some other type of data) typically has characteristics that are identifiable and associated with the gradients that are defined. By evaluating the data and looking for these characteristics, various embodiments can identify instances where gradients are defined. When the gradient instances are identified, that portion of data that defines the gradient can be replaced with a gradient operator which more efficiently defines the gradient.

When the data portion that is replaced comprises data of the display list, the gradient operator typically replaces a large number of color commands and vectors. The effect of replacing this large amount of data is that memory usage is reduced, thus reducing the processing overhead. Correspondingly, rendering performance is improved. This is due to the fact that the image processor or renderers typically have poor performance on very small vectors, such as those that typically define gradients.

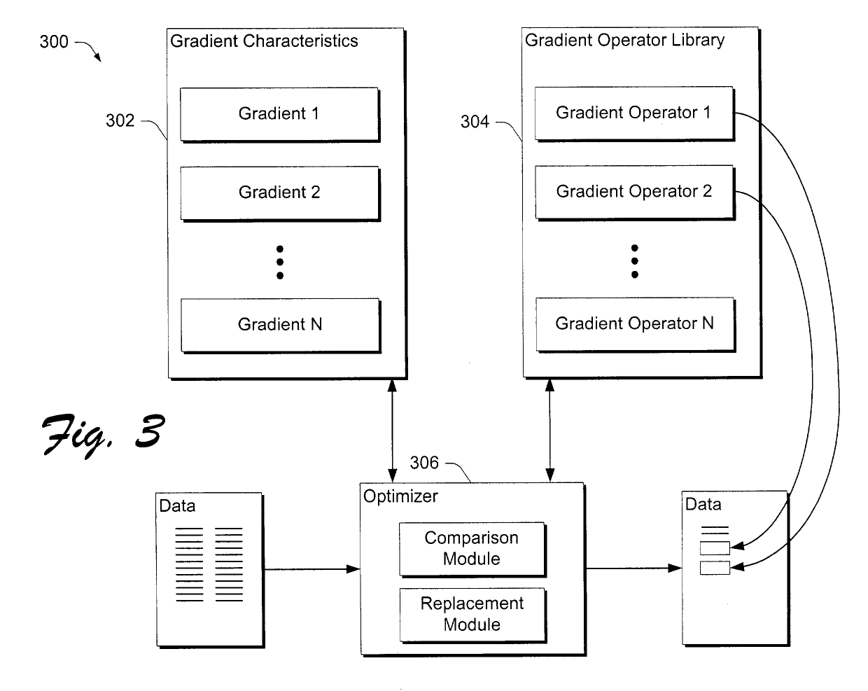

FIG. 3 illustrates components of an exemplary system 300 that can be utilized to improve printer performance insofar as gradient processing is concerned.

System 300 comprises a collection of gradient characteristics 302. In the illustrated example, the gradient characteristic collection comprises characteristics for individual gradients, illustrated here as Gradient 1 through Gradient N. The gradient characteristic collection can be defined in any suitable manner. For example, the gradient characteristic collection can be defined as sets of rules that define how the individual gradients should appear in the data that is analyzed. Thus, for example, assume that Gradient 1 is associated with a vertical gradient. Gradient 1 will accordingly embody characteristics that describe vertical gradients. As the types of data that define the gradients can vary, so too can the characteristics that are embodied in the collection of gradient characteristics.

System 300 also comprises a gradient operator library 304 that contains individual gradient operators that can be used to replace data that is evaluated and determined to contain or define a gradient. Here, individual gradient operators comprise Gradient Operator 1 through Gradient Operator N. In this example, there is a one-to-one correspondence between the individual gradients of the gradient characteristic collection 302 and the gradient operators of the gradient operator library 304. Some embodiments may have a many-to-one relationship between the gradient characteristic collection 302 and the gradient operators in the gradient operator library 304, wherein a number of rules may be present each producing the same gradient operator.

Individual gradient operators can be implemented in any suitable way. In one example, the gradient operator is implemented as a model of the gradient with which it is associated. The model can be embodied as an algorithmic representation of the gradient. Any suitable algorithmic representation of the gradient can be used. Typically, the algorithmic representations of the gradients will differ greatly as between different gradients. For gradients such as vertical and horizontal gradients, the algorithmic representation can be a fairly straight-forward representation. For more complex gradients, such as radial gradients and the like, the algorithmic representation will be more complicated. Characteristics of the algorithmic representations are that they can include parameters associated with a starting color and location(s), an ending color and location(s), and an interpolation function that defines how the transition is to be made between the two colors.

System 300 also comprises an optimizer 306 that functions to receive data associated with a display list, evaluate the data, and replace data portions that are identified to correspond to gradients. The optimizer component can be implemented in any suitable hardware, software, firmware or combination thereof. To that end, optimizer 306 effectively implements the method described above in connection with FIG. 2. Accordingly, optimizer 306 can comprise a comparison module and a replacement module.

Here, the comparison module compares data that is received with gradient characteristics that are embodied in the gradient characteristic collection 302. If the comparison module ascertains that a portion of the data that is evaluated compares favorably with a particular gradient characteristic (such as, for example, the characteristics associated with Gradient 1), then the replacement module accesses an associated gradient operator from gradient operator library 304 and replaces the data portion that achieved the favorable comparison with the associated gradient operator. Here, for example, to the left of optimizer 306 appears a collection of data (not specifically designated). Assume in this example that the optimizer ascertains that a portion of the data corresponds to a particular gradient operator that is contained in the gradient operator library 304. The optimizer thus replaces that data portion with the corresponding gradient operator, as indicated by the collection of data that is output from the optimizer. In this particular example, the collection of data that was evaluated by the optimizer contained two different gradients, as evidenced by the two individual gradient operators that are contained in the data collection that is output from the optimizer.

The comparison can be effected in any suitable way. For example, the data can be serially compared with the characteristics of each individual gradient. If a match or favorable comparison is not attained, those characteristics can be discarded and the characteristics for the next gradient can be evaluated. Alternately, comparison of the data can be conducted in more of a parallel fashion. Specifically, the starting point for the comparison can be all of the characteristics for multiple gradients. If a particular gradient is ruled out, that gradient is discarded until there is only one gradient left.

The optimizer 306 can be located at any suitable location between and including, without limitation, a host system that generates PDL for a printer, and the component or components that generate a display list.

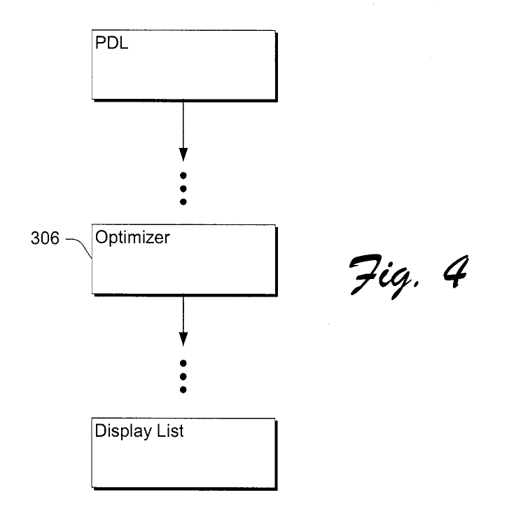

For example, FIG. 4 illustrates optimizer 306 as residing between a PDL layer and the display list. Additionally, the optimizer can be implemented in a manner that analyzes display list data once it has been created and provided into the strips. Alternately, the optimizer can be located at a point where it comprises part of the pipeline that processes data to ultimately provide the data into a display list. Here, the data would not necessarily be provided into the strips prior to having the gradient operators incorporated therewith.

Once the gradient operators have been inserted into the data, they can be suitably processed by the printing system to provide a suitably printed gradient. This processing can take place, for example, at extraction time or rendering time. In this example, the image processor or renderer is suitably configured to process the gradient operators that can be inserted into the data.

Implementation Example Using Display List Data

In one embodiment, the data that can be evaluated for purposes of determining whether a portion can be replaced with a gradient operator is data that typically comprises a display list. Recall that this data can comprise color commands and vectors that define gradients, as well as other data. One of the characteristics of this type of data is that if the data defines a gradient, then the vectors that are associated with data will typically be connected. That is, if the vectors are not connected, then the data typically does not define a gradient. If, however, the vectors are connected, then it is possible that the data defines a gradient.

As an example, to recognize a horizontal gradient, the above-described optimizer can look at combinations of color commands and vectors or rectangles, and can attempt to fit the combinations to characteristics that are associated with horizontal gradients. The characteristics might have, for example, a few parameters such as a linear model of a single color and a slope. The characteristics could however, be extended to quadratic or more complicated models. If the color commands and vectors favorably compare with the characteristics of the horizontal gradient, then that portion of the data can be replaced with the associated horizontal gradient operator. Accordingly, the display list will now contain, instead of color commands and vectors defining a gradient, the corresponding gradient operator.

To recognize vertical gradients, much the same operation can be utilized, although the optimizer will now look for vertical joins rather than horizontal joins.

Diagonal and radial gradients can also be recognized, but the process of doing so can depend a great deal on the structure of the display list marking commands. Recognizing smooth shading would best be done in small steps, so a single smooth shading command might be turned into many display list gradient operators.

Conclusion

Gradients take up a lot of space on the display list and, accordingly, in memory. Gradients also consume a great deal of processing time if a gradient operator is not used. By scanning data for gradients and replacing associated gradient data with gradient operators, display list space (and accordingly memory space) and processing time can be more efficiently used. In host-based systems that send display lists to printers, the above-described embodiments can reduce the amount of data that is sent over the connection to the printer.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
evaluating data associated with a print job to ascertain whether at least a portion of the data is associated with a gradient; and
replacing at least a portion of the data with a gradient operator if said portion is determined to be associated with the gradient.

2. The method of claim 1, wherein the gradient comprises a color gradient.

3. The method of claim 1, wherein the act of evaluating is performed by evaluating data associated with a PDL that defines the print job.

4. The method of claim 1, wherein the act of evaluating is performed by evaluating commands associated with the print job.

5. The method of claim 1, wherein the act of evaluating is performed by evaluating commands associated with the print job, said commands comprising commands associated with colors and vectors.

6. The method of claim 1, wherein the act of evaluating is performed by a printer.

7. One or more computer-readable media having computer-readable instructions thereon which, when executed by one or more processors, cause the one or more processors to:
evaluate data associated with a print job to ascertain whether at least a portion of the data is associated with a gradient; and
replace at least a portion of the data with a gradient operator if said portion is determined to be associated with the gradient.

8. The computer-readable media of claim 7, wherein the gradient comprises a color gradient.

9. The computer-readable media of claim 7, wherein the data is evaluated by evaluating commands associated with the print job.

10. A printer embodying the computer readable media of claim 7.

11. A host computer embodying the computer readable media of claim 7.

12. A method comprising:
evaluating display list data to ascertain whether the display list data is associated with a gradient; and
if the display list data is associated with the gradient, replacing the display list data with a gradient operator effective to substantially produce the gradient on a print medium.

13. The method of claim 12, wherein said act of evaluating comprises evaluating characteristics associated with said display list data.

14. The method of claim 12, wherein said act of evaluating comprises evaluating one or more of: color commands and vectors.

15. The method of claim 12, wherein said act of evaluating comprises ascertaining whether one or more vectors are joined together sufficient to define a gradient.

16. A system comprising:
a collection of gradient characteristics comprising characteristics of individual gradients;
a gradient operator library that contains individual gradient operators that can be used to define a gradient; and
an optimizer component configured to evaluate data associated with a print job and replace data that is identified to be associated with a gradient with an associated gradient operator.

17. The system of claim 16, wherein the characteristics are defined as rules that define how individual gradients appear in data that represents a print job.

18. The system of claim 16, wherein individual gradient operators comprise an algorithmic representation of a gradient with which it is associated.

19. The system of claim 16, wherein individual gradient operators comprise an algorithmic representation of a gradient with which it is associated, individual gradient operators comprising parameters associated with starting colors, ending colors, locations, and an interpolation function that defines an interpolation between the starting and ending colors.

20. The system of claim 16, wherein the optimizer component is configured to compare the data that is associated with a print job with characteristics of gradients contained in the collection of gradient characteristics and replace portions of data that are determined to define gradients with a gradient operator from the gradient operator library.

21. The system of claim 16, wherein the optimizer component is configured to evaluate display list data.

22. The system of claim 16, wherein the optimizer component is embodied on a host computer.

23. The system of claim 16, wherein the optimizer component is embodied on a printer.

24. A printer comprising:
a collection of gradient characteristics comprising characteristics of individual gradients;
a gradient operator library that contains individual gradient operators that can be used to replace data that is evaluated and determined to define a gradient;
an optimizer component configured to evaluate display list data associated with a print job and replace display list data that is identified to be associated with a gradient with an associated gradient operator;
a rasterizer module configured to process gradient operators and provide rasterized data associated with the gradient operators; and
a print engine configured to render the rasterized data.

25. The printer of claim 24, wherein the characteristics are defined as rules that define how individual gradients appear in data that represents a print job.

26. The printer of claim 24, wherein individual gradient operators comprise an algorithmic representation of the gradient with which it is associated.

27. The printer of claim 24, wherein individual gradient operators comprise an algorithmic representation of the gradient with which it is associated, individual gradient operators comprising parameters associated with starting colors, ending colors, locations, and an interpolation function that defines an interpolation between the starting and ending colors.

28. The printer of claim 24, wherein the optimizer component is configured to compare the display list data that is associated with a print job with characteristics of gradients contained in the collection of gradient characteristics and replace portions of the display list data that are determined to define gradients with a gradient operator from the gradient operator library.

29. The printer of claim 24, wherein gradient operators are associated with one or more of horizontal gradients and vertical gradients.

30. A method comprising:
a step for evaluating display list data associated with a print job to ascertain whether the display list data defines a color gradient; and
a step for incorporating a gradient operator in place of portions of the display list data if said portions define a color gradient.

31. The method of claim 30, wherein the display list data comprise commands associated with colors and vectors.

32. An apparatus comprising:
an optimizer component configured to:
receive data associated with a display list; and
evaluate the data and replace data portions with a gradient operator if said data portions correspond to a gradient.

33. The apparatus of claim 32, wherein said optimizer component comprises a software component.

34. The apparatus of claim 32, wherein said optimizer component comprises a comparison module for comparing data with gradient characteristics that as associated with individual gradients.

35. The apparatus of claim 32, wherein said optimizer component comprises a replacement module for accessing gradient operators from a gradient operator library and replacing individual data portions with an associated gradient operator.

36. The apparatus of claim 32, wherein said optimizer component comprises:
a comparison module for comparing data with gradient characteristics that as associated with individual gradients; and
a replacement module for accessing gradient operators from a gradient operator library and replacing individual data portions with an associated gradient operator.
